(19) United States
(12) Patent Application Publication
(10) Pub. No.: US 2023/0245535 A1
(43) Pub. Date: Aug. 3, 2023

(54) SYSTEMS AND METHODS FOR SELF-CHECKOUT VERIFICATION

(71) Applicant: Walmart Apollo, LLC, Bentonville, AR (US)

(72) Inventors: Zhichun Xiao, Plano, TX (US); Lingfeng Zhang, Dallas, TX (US); Yutao Tang, Allen, TX (US); Mingquan Yuan, Flower Mound, TX (US); Tianyi Mao, Chicago, IL (US); Han Zhang, Plano, TX (US); Chunmei Wang, Dallas, TX (US); Feiyun Zhu, Allen, TX (US); Zhaoliang Duan, Frisco, TX (US); Yanmei Jin, Dallas, TX (US); Jing Wang, Dallas, TX (US); Wei Wang, Dallas, TX (US); Ranran Cao, Dallas, TX (US); Zhiwei Huang, Flower Mound, TX (US)

(21) Appl. No.: 18/160,837

(22) Filed: Jan. 27, 2023

Related U.S. Application Data
(60) Provisional application No. 63/304,926, filed on Jan. 31, 2022.

(51) Int. Cl. G07G 3/00; G06V 20/52; G06V 10/764; G06V 20/62; G06V 10/22; G06V 10/74; G06V 10/12

(52) U.S. Cl. CPC G07G 3/003; G06V 10/12; G06V 10/74; G06V 10/225; G06V 10/764; G06V 20/52; G06V 20/63

(57) ABSTRACT

In some embodiments, apparatuses and methods are provided herein useful to self-checkout verification at a retail facility. In some embodiments, there is provided a system for self-checkout verification at a retail facility including a first optical imaging unit; and a control circuit. The control circuit configured to: receive purchase receipt data; receive one or more images of the items in the container; and execute a machine learning model trained to: perform item detection, item classification, and item verification of each item shown in the one or more images; and output electronic data corresponding to an electronic receipt of the items in the container. The control circuit may automatically detect each unpaid item in the container based on a comparison of the purchase receipt data with the electronic data; and provide an alert signal in response to automatically detecting an unpaid item.

### CROSS-REFERENCE TO RELATED APPLICATION(S)

This application claims the benefit of U.S. Provisional Application No. 63/304,926 filed Jan. 31, 2022, which is incorporated herein by reference in its entirety.

### TECHNICAL FIELD

This invention relates generally to self-checkout verification.

### BACKGROUND

Generally, after a customer pays for the purchased items at a retail facility, the customer will have to show a purchased receipt to an associate before leaving the retail facility in order for the associate to verify that the items in the customer’s cart or in the customer’s possession have been paid. However, this may result in assigning some of the associates to perform this task when the associates time can be better utilized elsewhere in the retail facility. Additionally, there may result in unnecessary long customer lines just to leave the retail facility.

### BRIEF DESCRIPTION OF THE DRAWINGS

Disclosed herein are embodiments of systems, apparatuses and methods pertaining to self-checkout verification at a retail facility. This description includes drawings, wherein:

FIG. 1 illustrates a simplified block diagram of an exemplary system for self-checkout verification at a retail facility in accordance with some embodiments;

FIG. 2 illustrates an exemplary system for self-checkout verification at a retail facility in accordance with some embodiments;

FIG. 3 illustrates an exemplary system for self-checkout verification at a retail facility in accordance with some embodiments;

FIG. 4 illustrates an example augmented image in accordance with some embodiments;

FIG. 5 shows a flow diagram of an exemplary method of self-checkout verification at a retail facility in accordance with some embodiments;

FIG. 6 shows a flow diagram of an exemplary method of self-checkout verification at a retail facility in accordance with some embodiments;

FIG. 7 is an illustrative example of an electronic device in accordance with some embodiments;

FIG. 8 shows a flow diagram of an exemplary method of self-checkout verification at a retail facility in accordance with some embodiments; and

FIG. 9 illustrates an exemplary system for use in implementing methods, techniques, devices, apparatuses, systems, servers, sources and self-checkout verification at a retail facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for self-checkout verification at a retail facility. In some embodiments, a system for self-checkout verification at a retail facility includes an optical imaging unit mounted at a location proximate an exit of the retail facility. The optical imaging unit may obtain data from a purchase receipt and/or images of items placed into a container by a customer. The system includes a control circuit communicatively coupled to the optical imaging unit via a communication network. In some embodiments, the control circuit receives purchase receipt data in response to the optical imaging unit scanning a machine-readable identifier of the purchase receipt. In some embodiments, the control circuit receives one or more images of the items in the container captured by the optical imaging unit in response to the scanning of the machine-readable identifier of the purchase receipt. The control circuit executes a machine learning model trained to perform item detection, item classification, and item verification of each item shown in the one or more images to automatically identify the items in the container, and/or output electronic data corresponding to an electronic receipt of the items in the container that were identified by the machine learning model. In some embodiments, the control circuit automatically detects each unpaid item of the items in the container based on a comparison of the purchase receipt data with the electronic data. In some embodiments, the control circuit provides an alert signal in response to automatically detecting an unpaid item.

In some embodiments, a method for self-checkout verification at a retail facility includes obtaining, by an optical imaging unit mounted at a location proximate an exit of the retail facility, data from a purchase receipt and images of items placed into a container by a customer. The method may include receiving, by a control circuit communicatively coupled to the optical imaging unit via a communication network, purchase receipt data in response to the optical imaging unit scanning a machine-readable identifier of the purchase receipt. The method may include receiving, by the control circuit, one or more images of the items in the container captured by the optical imaging unit in response to the scanning of the machine-readable identifier of the purchase receipt. In some embodiments, the method includes executing, by the control circuit, a machine learning model trained to perform item detection, item classification, and item verification of each item shown in the one or more images to automatically identify the items in the container, and/or output electronic data corresponding to an electronic receipt of the items in the container that were identified by the machine learning model. The method may include automatically detecting, by the control circuit, each unpaid item of the items in the container based on a comparison of the purchase receipt data with the electronic data. The method may include providing, by the control circuit, an alert signal in response to automatically detecting an unpaid item.

The present disclosure is a self-serve checkout shrinkage reduction systems and methods that prevent shrinkage in self-checkout terminals at retail facilities and/or exit door areas. The present disclosure is applicable in purchase transactions occurring at retail facilities including at a cashier, scan and go and self-checkout. The present disclosure provides no-touch and self-service for customers.

Additional disclosures are provided in U.S. Application No. 16/931,076 filed Jul. 16, 2020 and PCT Application No. PCT/US20/60120 filed Nov. 12, 2020, all which are incorporated herein by reference in their entirety.

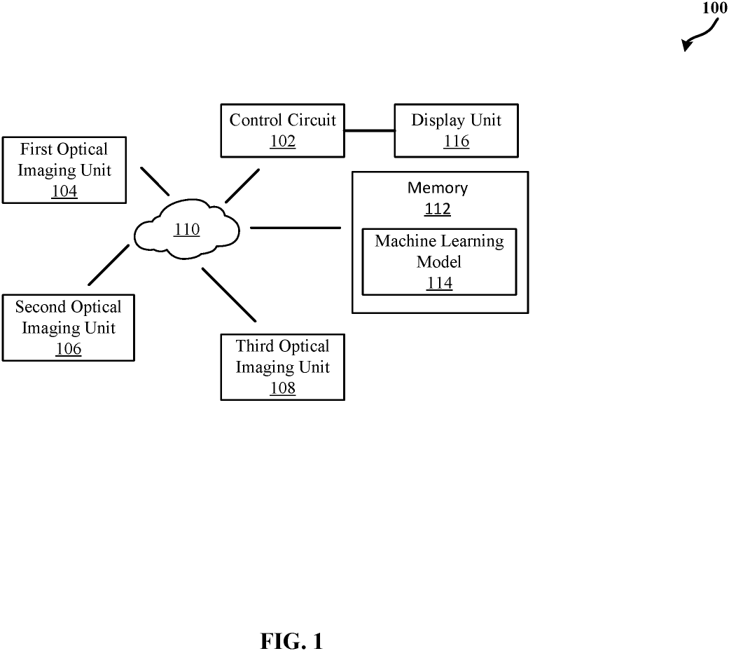

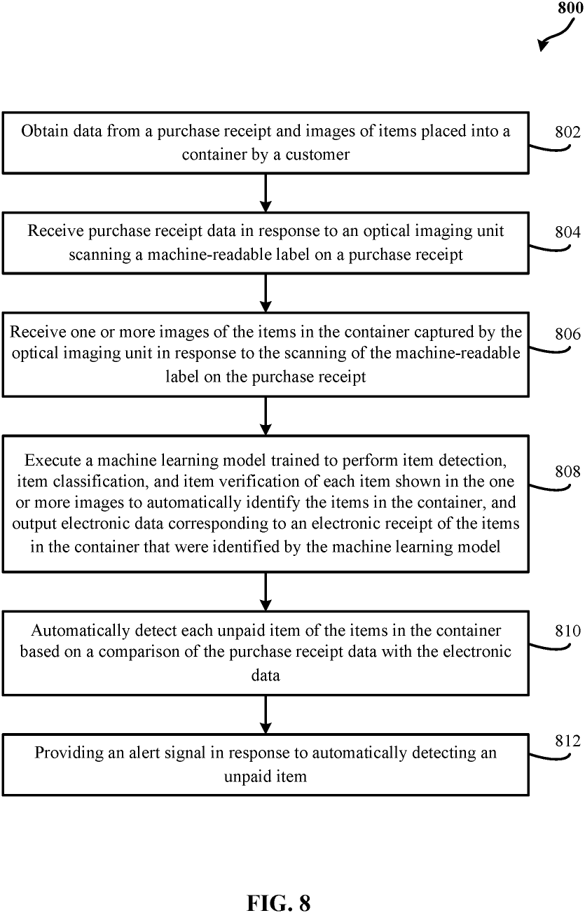

FIG. 1 is described along with FIG. 8. FIG. 1 illustrates a simplified block diagram of an exemplary system 100 for self-checkout verification at a retail facility in accordance with some embodiments. FIG. 8 shows a flow diagram of an exemplary method 800 of self-checkout verification at a retail facility in accordance with some embodiments. The system 100 includes a first optical imaging unit 104 mounted at a location proximate an exit of the retail facility. At step 802, the first optical imaging unit 104 may obtain data from a purchase receipt and images of items placed into a container by a customer. The system 100 further includes a control circuit 102 communicatively coupled to the first optical imaging unit 104 via a communication network 110. In some embodiments, the communication network 110 includes Internet, a local area network, a wide area network, and/or any private and/or public network capable of communicatively coupling or providing electronic infrastructure for exchanging electronic data between one electronic device to one or more electronic devices. For example, at step 804, the control circuit 102 receives purchase receipt data in response to the first optical imaging unit 104 scanning a machine-readable identifier of the purchase receipt. At step 806, the control circuit 102 may receive one or more images of the items in the container captured by the first optical imaging unit 104 in response to the scanning of the machine-readable identifier of the purchase receipt. In some configurations, the first optical imaging unit 104 includes a camera capable of scanning a machine-readable identifier and capturing one or more images of items in a container. In some embodiments, the container includes a shopping cart, a shopping basket, a shopping bag, and/or any storage container capable of holding items purchased and/or to be purchased by a customer. In some configurations, the first optical imaging unit 104, the first optical imaging unit 104 includes a camera and a separate scanner. In such a configuration, the camera captures images of the items in the container and the scanner scans machine-readable identifier/s. In some embodiments, a machine-readable identifier includes a barcode (e.g., 1D barcode, 2D barcode, and 3D barcode, to name a few) and/or a QR code. In some embodiments, the machine-readable identifier may include an identifier of a receipt, such as a bar code label on a printed receipt and/or a digital identifier or code on an electronic receipt (via app or email, for example).

At step 808, the control circuit 102 may execute a machine learning model 114 trained to perform item detection, item classification, and/or item verification of each item shown in the one or more images to automatically identify the items in the container. Further, at step 808, the control circuit 102 may execute the machine learning model 114 trained to output electronic data corresponding to an electronic receipt of the items in the container that were identified by the machine learning model 114. In some embodiments, at step 810, the control circuit 102 automatically detects each unpaid item of the items in the container based on a comparison of the purchase receipt data with the electronic data. In some embodiments, at step 812, the control circuit 102 provides an alert signal in response to automatically detecting an unpaid item. In some embodiments, the machine learning model 114 is stored in a memory 112. In some embodiments, the memory 112 includes hard disk drives, solid state drives, optical storage devices, flash memory devices, random access memory, read only memory, and/or cloud storage devices.

In some embodiments, the machine learning model 114 may be based on a machine learning algorithm including a supervised learning, an unsupervised learning, a reinforcement learning, binary classification, Support Vector Machine (SVM), artificial neural networks, convolutional neural networks, You Only Look Once (YOLO), RetinaNet, Regional based CNN (RCNN), Fast-RCNN, Faster-RCNN, and Mask RCNN, and/or any one or more open-sourced machine learning algorithm available to public for download and use. Those skilled in the art will recognize that the embodiments described herein can use one or more publicly known and/or privately created machine learning algorithm without departing from the scope of the invention. In some embodiments, the machine learning algorithm may be iteratively input a plurality of images of various items in order for the machine learning algorithm to output a machine learning model 114 that is able to and/or trained to automatically identify and/or recognize items generally sold and/or purchased at a retail facility within a predetermined accuracy. In the item detection step, to make sure our model can detect all types of products from different angles, we designed algorithm to create 3D model of representative products and simulated thousands of shopping carts with different product combinations. In the item recognition step, our model not only considers the text information of each product including how large is the text and where it is positioned on the product, the model also considers the packaging features like color and shape of a product. In the verification step, our model can tell or identify whether a captured or a cropped shopping cart image includes a single product or not with high confidence to reduce false positive predictions based on synergy of text, color and shape features. In some embodiments, the control circuit 102 may find or detect all the possible items in a cart (e.g., the container 204) and draw bounding boxes on those found/detected items. By one approach, if there is only one item found/detected, the control circuit 102 may draw one bounding box. By another approach, if there are ten items found/detected, the control circuit 102 may draw ten bounding boxes. In response, for each bounding box, the control circuit 102 may determine what the item found/detected is based on an associated confidence score. In some embodiments, the control circuit 102 may determine the confidence score by comparing text and image features of each item image in the bounding box with stored images of items in a database accessible by the control circuit 102. For example, the database includes training templates of all the UPCs (e.g., images of items with associated UPCs used to train the machine learning model 114). The confidence score may be a combined weighted score based on similarities of text, color and shape features of each found/detected item with a particular item associated with a stored image. In some embodiments, the determined confidence score is compared with a predetermined threshold by the control circuit 102. By one approach, if the determined confidence score is at least equal to the predetermined threshold, the control circuit 102 may determine that the detected/found item is the same item as the particular item associated with the stored image that the detected/found item is compared with.

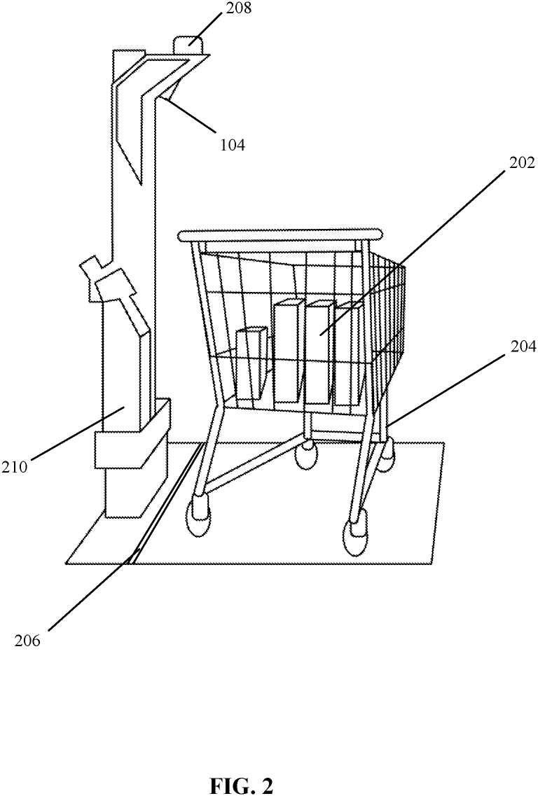

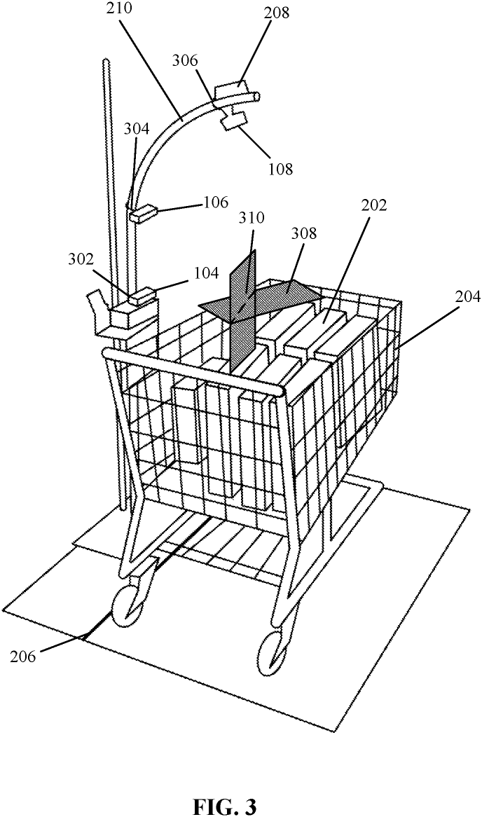

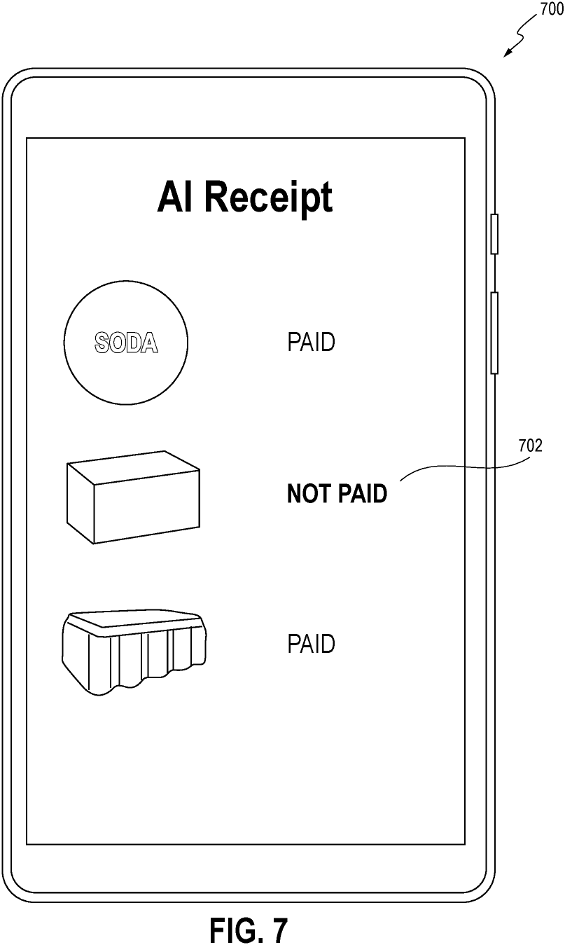

FIGS. 2 and 3 illustrate example system 100 of FIG. 1. In some embodiments, the first optical imaging unit 104 is secured at a post 210, for example as shown in FIGS. 2 and 3. In some embodiments, the post 210 is located proximate an exit of a retail facility. In some embodiments, the first optical imaging unit 104 is secured at a first portion 302 of a post 210 located proximate an exit of a retail facility. In some embodiments, the system 100 includes a second optical imaging unit 106 secured at a second portion 304 of the post 210 such that the second optical imaging unit 106 is oriented at an angle relative to an imaginary horizontal plane 308 of a container 204. For example, the imaginary horizontal plane 308 may be a plane substantially parallel to a surface of a floor proximate the first optical imaging unit 104, the second optical imaging unit 106, and/or the third optical imaging unit 108. In some embodiments, the container 204 corresponds to the container of system 100 of FIG. 1. In some embodiments, the first optical imaging unit 104 is secured to the first portion 302 of the post 210 such that the first optical imaging unit 104 is oriented perpendicular relative to an imaginary vertical plane 310 of the container 204. For example, the imaginary vertical plane 310 may be a plane substantially perpendicular to the surface of the floor proximate the first optical imaging unit 104, the second optical imaging unit 106, and/or the third optical imaging unit 108. In some embodiments, the system 100 includes a third optical imaging unit 108 secured to a third portion 306 of the post 210 such that the third optical imaging unit 108 is oriented parallel relative to the imaginary horizontal plane 308 of the container 204. In some embodiments, the system 100 includes a floor marking 206 that guides the container 204 in an alignment with the post 210. For example, the floor marking 206 may include a marking on a surface of a floor of the retail facility and/or a marking on a mat. In some embodiments, the system 100 includes a light emitting device 208. For example, the alert signal provided by the control circuit 102 in response to automatically detecting an unpaid item among items 202 in the container 204 is provided to the light emitting device 208 and/or an electronic device associated with an associate of the retail facility. For example, FIG. 7 is an illustrative example of an electronic device 700 displaying a representative visual image of an alert signal indicating an unpaid item 702 among items 202 in a container 204.

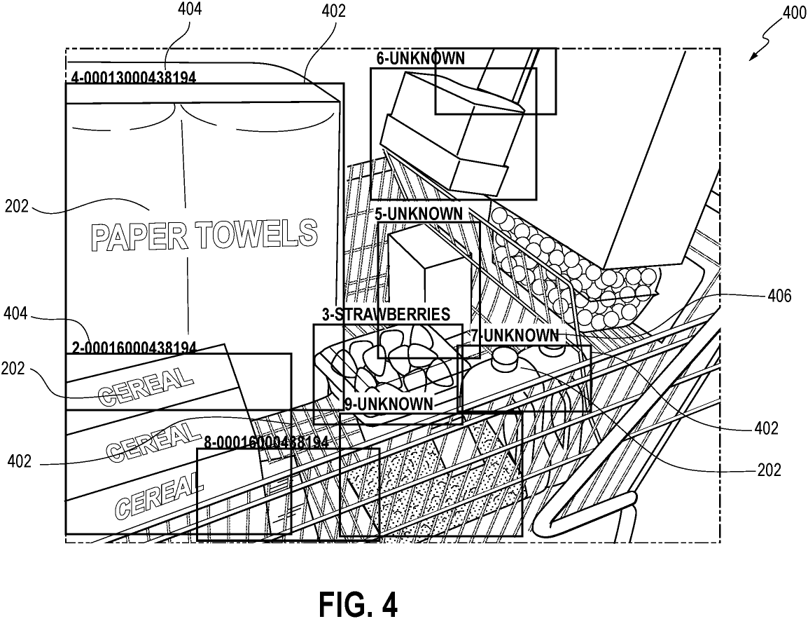

FIG. 4 illustrate an example augmented image 400. In some embodiments, in performing item detection, item classification, and/or item verification of each item shown in the one or more images, the control circuit 102, in executing the machine learning model 114, augments one or more images with a bounding box 402 around each item 202 and/or with a corresponding identification data 404 associated with each detected and recognized item. In some embodiments, the control circuit 102, in executing the machine learning model 114, augments one or more images with an identification data 406 associated with each detected and unrecognized item indicating that the detected item is unknown and/or not recognized by the machine learning model 114. In some embodiments, the performance of the item detection includes augmenting the one or more images with a bounding box 402 around each detected item in the one or more images. Alternatively or in addition, the performance of the item classification includes recognizing at least one or more of texts and illustrations on each detected item. Alternatively or in addition, the performance of the item verification includes comparing each detected and recognized item in the one or more images with a stored image of a comparable item in a database accessible by the control circuit 102. In some embodiments, the database is stored in the memory 112. Alternatively or in addition, the machine learning model 114 may be further trained to store in a memory storage (e.g., the memory 112) a corresponding image of the electronic data corresponding to an electronic receipt of the items 202 in the container 204 that were identified by the machine learning model 114. For example, the corresponding image includes one or more images captured by the first optical imaging unit 104, the second optical imaging unit 106, and/or the third optical imaging unit 108 augmented with the bounding box 402 around each detected and recognized item and /or corresponding identification data 404 of each detected item and recognized item. In some embodiments, the corresponding identification data 404 includes a universal product (UPC) code, a global trade item (GTIN) number, and/or any other product identification information that can be associated with an item for purchase. In some embodiments, the system 100 includes a display unit 116. For example, the control circuit 102 may cause a display unit 116 mounted at a location proximate an exit to prompt a customer to scan a machine-readable identifier of a purchase receipt in order to initiate a self-checkout verification prior to exiting a retail facility.

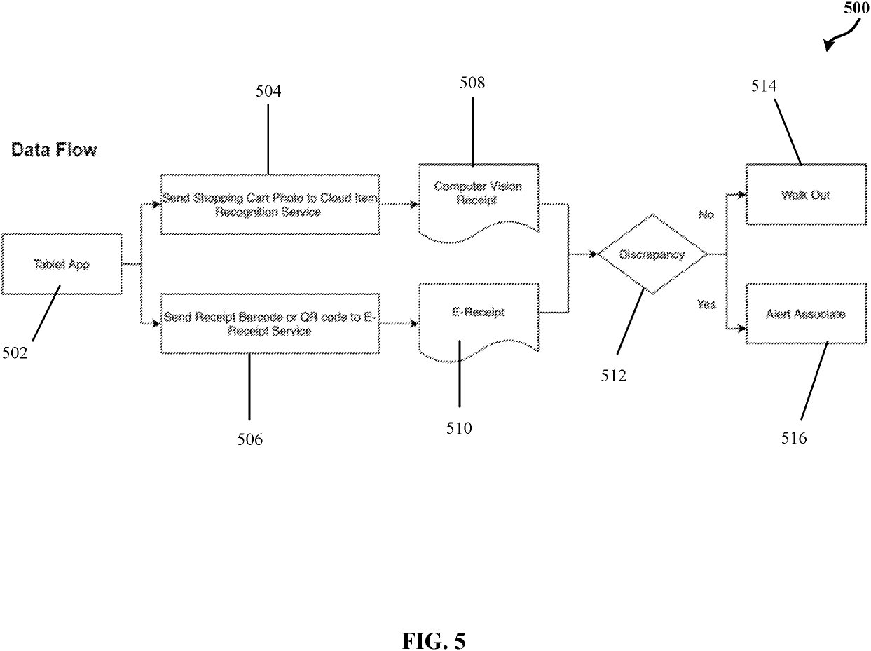

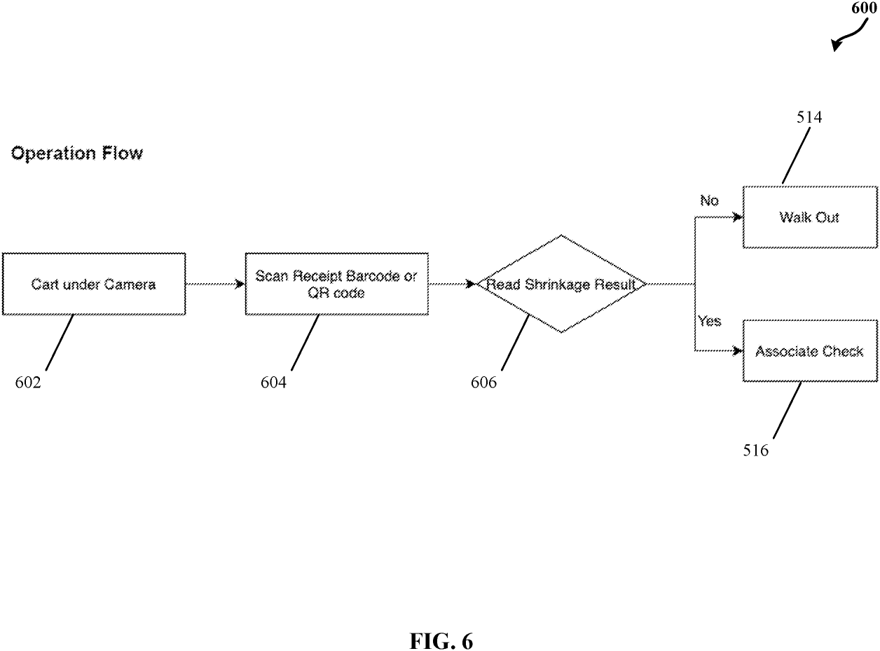

FIGS. 5 and 6 show flow diagrams of exemplary methods 500 and 600 of self-checkout verification at a retail facility in accordance with some embodiments. In some embodiments, the exemplary method 500 and/or the method 600 are implemented in the system 100 of FIG. 1. In an illustrative non-limiting example, a customer prior to exiting a retail facility places a shopping cart (e.g., a container 204) under a camera (e.g., the first optical imaging unit 104, the second optical imaging unit 106, and/or the third optical imaging unit 108), at step 602. At step 502, an application installed in an electronic device communicatively coupled to the control circuit 102 recognizes when the shopping cart is placed and/or parked under the camera and automatically captures an image of the items in the shopping cart. At step 504, the image of the items in the shopping cart is received by the control circuit 102 and a cloud item recognition service (e.g., one of layers in the machine learning model 114) outputs electronic data corresponding to an electronic receipt of the items in the shopping cart. For example, at step 508, a computer vision receipt is output by the cloud item recognition service. At step 604, the camera scans a machine-readable identifier (e.g., a barcode or QR code) on a purchase receipt. At step 506, the purchase receipt data is received by the control circuit 102 in response to the camera scanning a machine-readable identifier of the purchase receipt. For example, at step 510, an e-receipt service (e.g., another one of layers in the machine learning model 114) outputs an e-receipt. At step 512, the control circuit 102 may determine a discrepancy between the e-receipt and the computer vision receipt. In some embodiments, at step 606, the control circuit 102 outputs a read shrinkage result identifying whether there is a discrepancy between the e-receipt and the computer vision receipt. By one approach, at step 514, the control circuit 102 may provide an indication (e.g., a message displayed on the display unit 116 or a visual cue) to the customer that the customer may proceed to leave the retail facility or walk out of the retail facility when there is no discrepancy between the e-receipt and the computer vision receipt. By another approach, at step 516, the control circuit 102 may provide an alert signal to an electronic device associated with an associate of the retail facility and/or a light emitting device (e.g., a light emitting diode). For example, the associate may review the purchase receipt and the contents of the shopping cart.

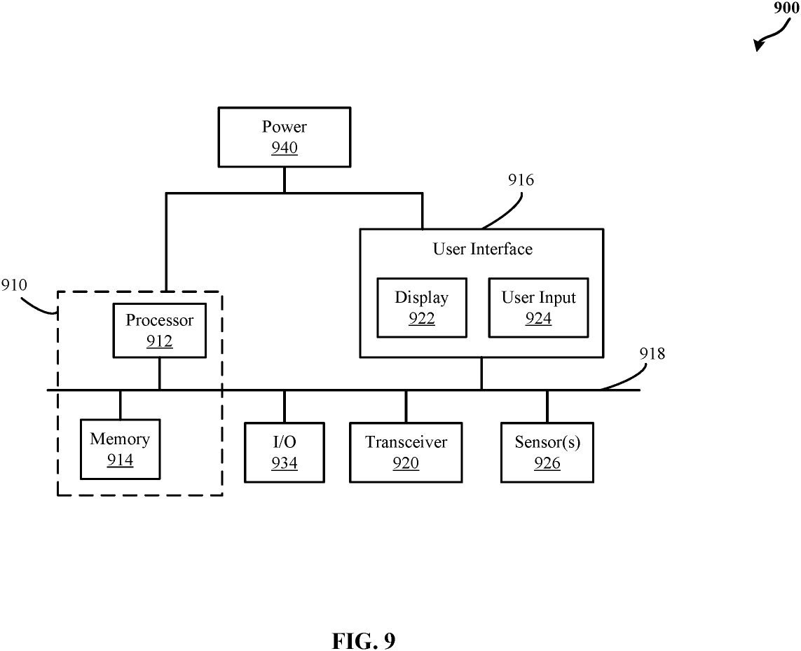

Further, the circuits, circuitry, systems, devices, processes, methods, techniques, functionality, services, servers, sources and the like described herein may be utilized, implemented and/or run on many different types of devices and/or systems. FIG. 9 illustrates an exemplary system 900 that may be used for implementing any of the components, circuits, circuitry, systems, functionality, apparatuses, processes, or devices of the system 100 of FIG. 1, the method 500 of FIG. 5, the method 600 of FIG. 6, and/or other above or below mentioned systems or devices, or parts of such circuits, circuitry, functionality, systems, apparatuses, processes, or devices. For example, the system 900 may be used to implement some or all of the system for self-checkout verification at a retail facility, the control circuit 102, the first optical imaging unit 104, the second optical imaging unit 106, the third optical imaging unit 108, the display unit 116, the memory 112, and/or other such components, circuitry, functionality and/or devices. However, the use of the system 900 or any portion thereof is certainly not required.

By way of example, the system 900 may comprise a processor module (or a control circuit) 912, memory 914, and one or more communication links, paths, buses or the like 918. Some embodiments may include one or more user interfaces 916, and/or one or more internal and/or external power sources or supplies 940. The control circuit 912 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 912 can be part of control circuitry and/or a control system 910, which may be implemented through one or more processors with access to one or more memory 914 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 900 may be used to implement one or more of the above or below, or parts of, components, circuits, systems, processes and the like. For example, the system 900 may implement the system for self-checkout verification at a retail facility with the control circuit 102 being the control circuit 912.

The user interface 916 can allow a user to interact with the system 900 and receive information through the system. In some instances, the user interface 916 includes a display 922 and/or one or more user inputs 924, such as buttons, touch screen, track ball, keyboard, mouse, etc., which can be part of or wired or wirelessly coupled with the system 900. Typically, the system 900 further includes one or more communication interfaces, ports, transceivers 920 and the like allowing the system 900 to communicate over a communication bus, a distributed computer and/or communication network (e.g., a local area network (LAN), the Internet, wide area network (WAN), etc.), communication link 918, other networks or communication channels with other devices and/or other such communications or combination of two or more of such communication methods. Further the transceiver 920 can be configured for wired, wireless, optical, fiber optical cable, satellite, or other such communication configurations or combinations of two or more of such communications. Some embodiments include one or more input/output (I/O) interface 934 that allow one or more devices to couple with the system 900. The I/O interface can be substantially any relevant port or combinations of ports, such as but not limited to USB, Ethernet, or other such ports. The I/O interface 934 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 926 to provide information to the system and/or sensor information that is communicated to another component, such as the control circuit 102, the first optical imaging unit 104, the second optical imaging unit 106, the third optical imaging unit 108, the display unit 116, the memory 112, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 900 comprises an example of a control and/or processor-based system with the control circuit 912. Again, the control circuit 912 can be implemented through one or more processors, controllers, central processing units, logic, software and the like. Further, in some implementations the control circuit 912 may provide multiprocessor functionality.

The memory 914, which can be accessed by the control circuit 912, typically includes one or more processor readable and/or computer readable media accessed by at least the control circuit 912, and can include volatile and/or nonvolatile media, such as RAM, ROM, EEPROM, flash memory and/or other memory technology. Further, the memory 914 is shown as internal to the control system 910; however, the memory 914 can be internal, external or a combination of internal and external memory. Similarly, some or all of the memory 914 can be internal, external or a combination of internal and external memory of the control circuit 912. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 914 can store code, software, executables, scripts, data, content, lists, programming, programs, log or history data, user information, customer information, product information, and the like. While FIG. 9 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for self-checkout verification at a retail facility comprising:
a first optical imaging unit mounted at a location proximate an exit of the retail facility, wherein the first optical imaging unit is configured to obtain data from a purchase receipt and images of items placed into a container by a customer; and
a control circuit communicatively coupled to the first optical imaging unit via a communication network, the control circuit configured to:
receive purchase receipt data in response to the first optical imaging unit scanning a machine-readable identifier of the purchase receipt;
receive one or more images of the items in the container captured by the first optical imaging unit in response to the scanning of the machine-readable identifier of the purchase receipt;
execute a machine learning model trained to:
perform item detection, item classification, and item verification of each item shown in the one or more images to automatically identify the items in the container; and
output electronic data corresponding to an electronic receipt of the items in the container that were identified by the machine learning model;
automatically detect each unpaid item of the items in the container based on a
comparison of the purchase receipt data with the electronic data; and
provide an alert signal in response to automatically detecting an unpaid item.

2. The system of claim 1, wherein the first optical imaging unit is secured at a first portion of a post located proximate the exit.

3. The system of claim 2, further comprising a second optical imaging unit secured at a second portion of the post such that the second optical imaging unit is oriented at an angle relative to an imaginary horizontal plane of the container, wherein the first optical imaging unit is secured to the first portion of the post such that the first optical imaging unit is oriented perpendicular relative to an imaginary vertical plane of the container.

4. The system of claim 3, further comprising a third optical imaging unit secured to a third portion of the post such that the third optical imaging unit is oriented parallel relative to the imaginary horizontal plane of the container.

5. The system of claim 2, further comprising a floor marking that guides the container in an alignment with the post.

6. The system of claim 1, wherein the first optical imaging unit comprises a camera.

7. The system of claim 1, wherein the container comprises a shopping cart.

8. The system of claim 1, wherein the machine-readable identifier comprises one of a barcode and a QR code.

9. The system of claim 1, wherein the alert signal is provided to at least one of an electronic device associated with an associate of the retail facility and a light emitting device.

10. The system of claim 1, wherein the performance of the item detection comprises augmenting the one or more images with a bounding box around each detected item in the one or more images, wherein the performance of the item classification comprises recognizing at least one or more of texts and illustrations on each detected item, and wherein the performance of the item verification comprises comparing each detected and recognized item in the one or more images with a stored image of a comparable item in a database accessible by the control circuit.

11. The system of claim 10, wherein the machine learning model is further trained to store in a memory storage a corresponding image of the electronic data, wherein the corresponding image comprises the one or more images captured by the first optical imaging unit augmented with the bounding box around each detected and recognized item and corresponding identification data of each detected item and recognized item.

12. The system of claim 1, wherein the control circuit is further configured to cause a display unit mounted at the location proximate the exit to prompt the customer to scan the machine-readable identifier.

13. A method for self-checkout verification at a retail facility comprising:
obtaining, by a first optical imaging unit mounted at a location proximate an exit of the retail facility, data from a purchase receipt and images of items placed into a container by a customer;
receiving, by a control circuit communicatively coupled to the first optical imaging unit via a communication network, purchase receipt data in response to the first optical imaging unit scanning a machine-readable identifier of the purchase receipt;
receiving, by the control circuit, one or more images of the items in the container captured by the first optical imaging unit in response to the scanning of the machine-readable identifier of the purchase receipt;
executing, by the control circuit, a machine learning model trained to:
perform item detection, item classification, and item verification of each item shown in the one or more images to automatically identify the items in the container; and
output electronic data corresponding to an electronic receipt of the items in the container that were identified by the machine learning model;
automatically detecting, by the control circuit, each unpaid item of the items in the container based on a comparison of the purchase receipt data with the electronic data; and
providing, by the control circuit, an alert signal in response to automatically detecting an unpaid item.

14. The method of claim 13, wherein the first optical imaging unit comprises a camera.

15. The method of claim 13, wherein the container comprises a shopping cart.

16. The method of claim 13, wherein the machine-readable identifier comprises one of a barcode and a QR code.

17. The method of claim 13, wherein the alert signal is provided to at least one of an electronic device associated with an associate of the retail facility and a light emitting device.

18. The method of claim 13, wherein the performance of the item detection comprises augmenting the one or more images with a bounding box around each detected item in the one or more images, wherein the performance of the item classification comprises recognizing at least one or more of texts and illustrations on each detected item, and wherein the performance of the item verification comprises comparing each detected and recognized item in the one or more images with a stored image of a comparable item in a database accessible by the control circuit.

19. The method of claim 13, further comprising securing the first optical imaging unit at a first portion of a post located proximate the exit.

20. The method of claim 19, further comprising securing a second optical imaging unit at a second portion of the post such that the second optical imaging unit is oriented at an angle relative to an imaginary horizontal plane of the container, wherein the first optical imaging unit is secured to the first portion of the post such that the first optical imaging unit is oriented perpendicular relative to an imaginary vertical plane of the container.
